(19) United States
(12) Patent Application Publication
(10) Pub. No.: US 2026/0351129 A1
(43) Pub. Date: Nov. 5, 2026

(54) SYSTEM AND METHOD FOR SELECTING AND PRESENTING CONTENT TO AN INFANT

(71) Applicant: Gal PEER, Tel Aviv (IL)

(72) Inventor: Gal PEER, Tel Aviv (IL)

(21) Appl. No.: 19/483,322

(22) PCT Filed: May 19, 2024
(86) PCT No.: PCT/IL2024/050491

§ 371 Date: Nov. 11, 2025

Related U.S. Application Data
(60) Provisional application No. 63/505,078, filed on May 31, 2023.

(51) Int. Cl. G09B 5/02; G06F 3/01

(52) U.S. Cl. CPC G09B 5/02; G06F 3/013

(57) ABSTRACT

A system for selecting and presenting content to an infant, which may include: a projector configured to present content on a selected surface; a sensor configured to obtain information related to attention of an infant; and a processor configured to: based on the information related to an attention of the infant, at least one of select and update content to be presented to the infant; and control the projector to present the content.

### FIELD OF THE INVENTION

The present invention relates to the field of interactive teaching, and more particularly, to systems and methods for selecting and presenting content to an infant.

### BACKGROUND OF THE INVENTION

Educational stimulation at an early age, e.g., at the infant and toddler stage, may enhance learning ability as the child grows. However, keeping young children engaged in learning may be a challenge. Children generally thrive when participating in interactive activities but tend to lose focus when taking part in passive activities. Interactive educational methods, utilizing video material may be highly effective in conveying information to eager young minds. Currently, interactive teaching methods have been primarily directed to a classroom environment and to children beyond the infant and toddler stage.

### SUMMARY OF THE INVENTION

Embodiments of the present invention may provide a system for selecting and presenting content to an infant, the system may include: a projector configured to present content on a selected surface; a sensor configured to obtain information related to attention of an infant; and a processor configured to: based on the information related to an attention of the infant, at least one of select and update content to be presented to the infant; and control the projector to present the content.

In some embodiments, the sensor includes a camera or a three-dimensional scanner, and wherein the processor is configured to: based on signals from the sensor, determine a direction of gaze of the infant, and based on the direction of gaze, determine a measure of attention of the infant to the presented content.

In some embodiments, the processor is configured to define display parameters of the projector based on a location of the projector in a facility.

In various embodiments, the processor is configured to define a focus area of the projector based on the direction of gaze and/or presented content.

In some embodiments, the system includes a docking station in which the projector may be placed, the docking station comprising a location sensor configured to provide information concerning a location of the projector in a facility.

In some embodiments, the processor is configured to select a region in the selected surface and to control the projector to present the content in the selected region.

In some embodiments, the processor is configured to monitor parameters related to safety of the infant based on signals from the sensor.

In some embodiments, the system includes a multicolor light source, wherein the processor is configured to control the multicolor light source to illuminate a vicinity of the infant in different colors.

In some embodiments, the processor is configured to control the multicolor light source based on at least one of the presented content and ambient light.

In some embodiments, the projector includes a piece of material surrounding a lens of the projector and partly overlapping with the lens to smooth borders of the presented content.

In some embodiments, the system includes a mirrors assembly for projecting the presented content in a selected direction.

In some embodiments, the processor is configured to select infant-specific content based on information related to the infant.

In some embodiments, the processor is configured to, based on the information related the attention of the infant and information about the presented content, determine a deviation of the infant's attention from normal.

In some embodiments, the processor is configured to determine a measure of addiction of the infant to a system and to select the content based on the measure of addiction.

In some embodiments, the processor is configured to control the projector to provide feedback to the infant.

Embodiments of the present invention may provide a method of selecting and presenting content to an infant, the method may include, using a computing device operating a processor: based on information related to an attention of an infant, at least one selecting and updating content to be presented to the infant; and controlling a projector to present the content on a selected surface.

In some embodiments, the method includes: by a sensor, obtaining the information related to the attention of the infant to the presented content.

In some embodiments, the method includes: defining display parameters of the projector based on a location of the projector in a facility.

In various embodiments, the method includes defining a focus area of the projector based on the direction of gaze and/or presented content.

In some embodiments, the method includes: based on a signal from a sensor disposed in a docking station of a projector, determining a location of the projector in a facility.

In some embodiments, the method includes: controlling the projector to present the content in a selected region on the selected surface.

In some embodiments, the method includes: monitoring parameters related to safety of the infant based on signals from the sensor.

In some embodiments, the method includes: controlling a multicolor light source to illuminate a vicinity of the infant in different colors.

In some embodiments, the method includes: controlling the multicolor light source based on at least one of the presented content and ambient light.

In some embodiments, the method includes: selecting infant-specific content based on information related to the infant.

In some embodiments, the method includes: based on the information related to the attention of the infant to the presented content and information about the presented content, determining whether or not the infant's attention deviates from normal.

In some embodiments, the method includes: determining a measure of addiction of the infant; and selecting the content based on the measure of addiction.

In some embodiments, the method includes: controlling the projector to provide feedback to the infant.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout. In the accompanying drawings:

FIG. 1 is a block diagram of an exemplary computing device which may be used with embodiments of the present invention;

FIG. 2A is a block diagram of a system for selecting and presenting content to an infant, according to some embodiments of the invention;

FIGS. 2B and 2C are schematic illustrations of an infant and of components of the system for selecting and presenting content to an infant, according to some embodiments of the invention; and

FIG. 3 is a flowchart of a method of selecting and presenting content to an infant, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the present invention may provide a system that may improve the way in which content is selected and presented to an infant. The system may include a projector that may present content on a selected surface. The system may include a sensor (e.g., such as a camera or a three-dimensional (3D) scanner) that may obtain information related to the attention of an infant to presented content. The system may include a processor that may at least one of select and update content to be presented to the infant based on the information related to the attention of the infant and control the projector to present the content. Advantageously, the system may provide interactive teaching to infants and toddlers. The system may adapt the teaching material and/or the teaching pace to the ability and interest level of the infant. The system may optimize the learning process of the infant. The system may identify or detect talents and abilities of the infant. The system may identify learning or behavioral disorders of the infant (e.g., and thus allow an early intervention).

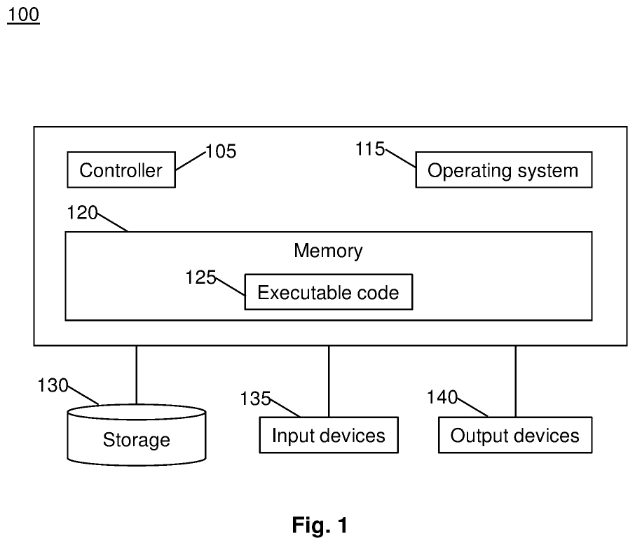

Reference is now made to FIG. 1, which is a block diagram of an exemplary computing device which may be used with embodiments of the present invention.

Computing device 100 may include a controller 105 that may be, for example, a central processing unit processor (CPU), a chip or any suitable computing or computational device, an operating system 115, a memory 120, a storage 130, input devices 135 and output devices 140. Each of modules and equipment such as a processor may be or include a computing device such as included in FIG. 1, although various units among these entities may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different, memory units. Memory 120 may store for example, instructions to carry out a method (e.g., code 125), and/or data such as user responses, interruptions, etc.

Executable code 125 may be any executable code, e.g., an application, a program, a process, task or script. Executable code 125 may be executed by controller 105 possibly under control of operating system 115. For example, executable code 125 may be a software application that performs methods as further described herein. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more controller(s) 105 may be configured to carry out embodiments of the present invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as video or other audio-visual content may be stored in a storage 130 and may be loaded from storage 130 into a memory 120 where it may be processed by controller 105.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g., memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

In some embodiments, some of the components shown in FIG. 1 may be omitted.

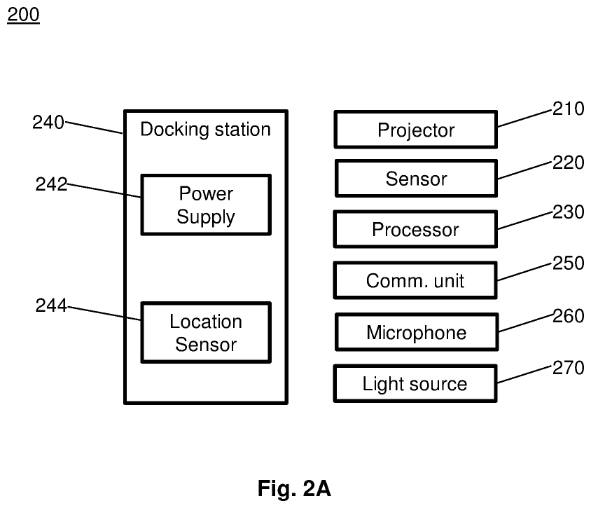

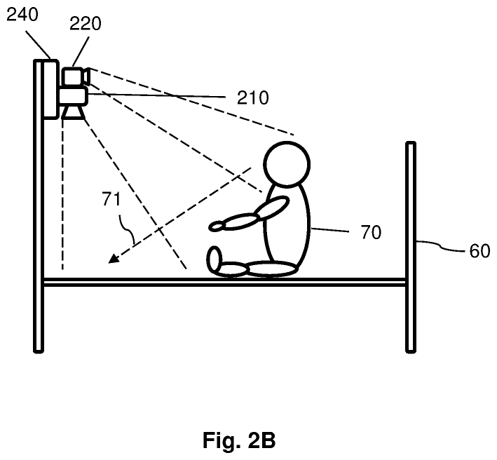

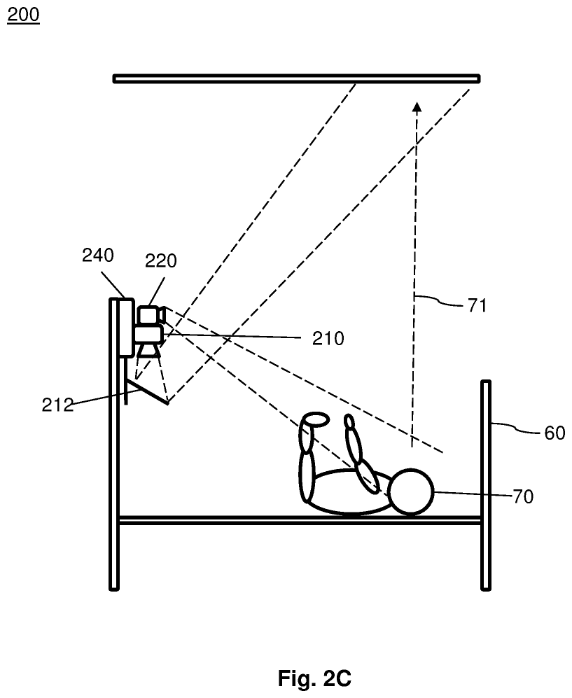

Reference is now made to FIG. 2A, which is a block diagram of a system 200 for selecting and presenting content to an infant 70, according to some embodiments of the invention.

Reference is also made to FIGS. 2B and 2C, which are schematic illustrations of infant 70 and of components of system 200 for selecting and presenting content to infant 70, according to some embodiments of the invention.

System 200 may include a projector 210. Projector 210 may present content on a selected surface. For example, the selected surface may be a surface of a bedsheet placed in a bed 60 of infant 70, a wall, a ceiling, a floor or any other suitable surface. Projector 210 may present two-dimensional (2D) content and/or three-dimensional (3D) content. Projector 210 may include a speaker to accompany the presented content with sound.

System 200 may include a sensor 220. Sensor 220 may obtain information related to the attention of infant 70 to the presented content. For example, sensor 220 may include a camera, a 3D scanner or any other suitable sensor. Sensor 220 may scan (e.g., periodically scan) the body of infant 70 to obtain and/or to monitor information related to attention of infant 70 to the presented content. The information related to attention of infant 70 to the presented content may, for example include a direction of gaze 71 of infant 70, a facial expression of infant 70, an orientation of a body of infant 70, an orientation of a face of infant 70, gestures of infant 70 and/or any other suitable parameter.

System 200 may include a processor 230. Based on signals from sensor 220, processor 230 may select and/or update the content to be presented to infant 70. For example, based on the signals from sensor 220, processor 230 may determine the direction of gaze 71 of infant 70. Based on the direction of gaze 71, processor 230 may determine a measure of the attention of infant 70 to the presented content. For example, if infant's gaze 71 is directed towards the presented content, it may be determined that infant 70 exhibits high attention to the presented content. In the same example, if infant's gaze 71 is not directed towards the presented content, it may be determined that infant 70 exhibits low attention to the presented content. If it is determined that infant 70 exhibits low attention to the presented content, processor 230 may update the presented content and/or select different content, for example until it is determined that infant 70 exhibits high attention to the updated and/or new content. Parameters other than the direction of gaze may be used by processor 230 to determine the measure of attention of infant 70 to the presented content. Such parameters may, for example, include the facial expression of infant 70, the orientation of the body and/or the face of infant 70, the gestures of infant 70 and/or any other suitable parameter. Processor 230 may control projector 210 to present the content.

System 200 may include a mirror assembly 212. Mirror assembly 212 may be coupled to projector 210, bed 60 or any other suitable object. Using mirror assembly 212, the content presented by projector 210 may be projected in a desired or selected direction. In the example of FIG. 2A, projector 210 may present the content onto the bedsheet placed in bed 60 of infant 70. If it is desired to present the content on a different surface, for example on the ceiling (e.g., when infant 70 lies on his back) mirror assembly 212 may be used to project the presented content onto the ceiling without changing the orientation and/or display configurations of projector 210, for example as shown in the example of FIG. 2B. In another example, projector 210 may be disposed on the bedsheet in bed 60 and present the content on the ceiling. In this example, mirror assembly 212 may project the content onto the bedsheet in bed 60 if needed. Other arrangements of projector 210 and/or mirror assembly 212 are possible. Mirror assembly 212 may be external to projector 210 (e.g., as shown in FIG. 2B). Mirror assembly 212 may be disposed within projector 210 and/or may be part of projector 210.

System 200 may include a docking station 240. Projector 210 may be coupled to docking station 240. Docking station 240 may include a power supply 242 to supply power to projector 210, processor 230 and/or any other suitable component of system 200. Docking station 240 may include a sensor 244. Sensor 244 may provide information concerning the location of docking station 240 in the facility. Sensor 244 may be, for example, a radio frequency identification (RFID) sensor or any other suitable sensor. Multiple docking stations 240 may be placed in multiple locations in the facility. For example, one docking station 240 may be placed in bed 60 of infant 70, another docking station 240 may be placed in the living room and yet another docking station 240 may be placed in the game room. Projector 210 (and/or other components of system 200 described herein) may be portable and may be switched between different docking stations 240 in the facility. For each location in the facility, display parameters of projector 210 may be predefined and stored in the memory of one of components of system 200. The display parameters of projector 210 may include a size of the displayed content, a size of elements in the displayed content, a resolution of the displayed content, a brightness of the displayed content, an orientation of the displayed content or any other suitable display parameter. When projector 210 is placed in docking station 240, processor 230 may determine the location of docking station 240 based on signals from sensor 244, and based on the determined location processor 230 may set the display parameters of projector 210.

Projector 210 may be placed and/or oriented by a parent or a supervisor of infant 70 to present the content on a selected surface. For example, projector 210 may be placed in bed 60 and oriented to present the content on the bedsheet (e.g., as shown in FIG. 2A). In another example, processor 230 may select (e.g., automatically select) the surface on which the content is to be presented. For example, a machine-readable optical label (e.g., such as a quick response (QR) code or any other suitable optical label) may be placed by the parent or the supervisor on the selected surface. Based on signals from sensor 220 or any other suitable sensor, processor 230 may detect the machine-readable optical label on the selected surface and control projector 210 to present the content on that selected surface. In another example, processor 230 may select the surface based on the direction of gaze 71 of infant 70. For example, if infant's gaze 71 is directed to the surface in the bed, processor 230 may control projector 210 to present the content on that surface.

Processor 230 may select a region in the selected surface and control projector 210 to present the content in the selected region. For example, based on signal from sensor 220 or any other suitable sensor, processor 230 may select a region in the selected surface that has no objects, drawing or any patterns that may interfere with the presented content.

Based on signals from sensor 220 or any other suitable sensor, processor 230 may determine whether or not the selected surface and/or the selected region are appropriate for presenting content. If it is determined that the selected surface and/or the selected region are not appropriate for presenting the content (e.g., if an object has been placed in the selected region), processor 230 may select new surface and/or new region on the selected surface and control projector 210 to present the content in the newly selected surface and/or the newly selected region.

Processor 230 may determine and/or adjust (e.g., automatically determine and/or adjust) the display parameters of projector 210. For example, processor 230 may determine and/or adjust the display parameters of projector 210 based on the distance between projector 210 and the selected surface and/or based on the position and/or orientation of projector 210 with respect to the selected surface. The distance may be provided to processor 210 by the user and/or automatically determined by processor 230 based on signals from sensor 220 or any other suitable sensor. For example, the longer the determined distance between projector 210 and the selected surface, the greater the size of the elements in the presented content may be selected.

Processor 230 may determine and/or adjust the focus area of projector 210. For example, processor 230 may determine and/or adjust the focus area of projector 210 to a part of the projected area where more action is taken place than in other parts of the projected area, like the top part of the projected area when a dialog between figures is taking place and focus should be given to faces, hands, and mouths. Processor 230 may determine and/or adjust the focus area of projector 210 based on the direction of the infant's gaze 71 if the infant's gaze 71 is within the projected area boundaries. If the infant gaze 71 is not within the projected area boundaries, processor 230 may determine and/or adjust the focus area of projection 210 to a part of the projected area where more action is taken place than in other parts. For example, processor 230 may determine that more action is happening on the bottom part of the projected area and may determine and/or adjust the focus area of projector 210 to the bottom part of the projected area.

Projector 210 may present content with smoothened borders. For example, projector 210 may include a piece of material surrounding a lens of the projector and partly overlapping with the lens. The piece of material surrounding the lens of the projector and partly overlapping with the lens may smooth borders of the presented content.

Processor 230 may select the content to be presented based on information related to infant 70. For example, processor 230 may select infant-specific content. The information related to infant 70 may, for example, include, an age, a gender, skills, known disorders, the measure of interest that infant 70 exhibits in response to content presented by system 200, the measure and/or duration of attention that infant 70 can exhibit in response to content presented by system 200 and/or any other suitable information related to infant 70. A portion of the information may be provided to processor 230 by the parent and/or the supervisor, for example using a communication unit 250 (e.g., wired or wireless communication unit). A portion of the information may be determined by processor 230 based on signals from sensor 220 and/or any other suitable sensor. For example, processor 230 may process signals obtained by sensor 220 and/or any other suitable sensor over a period of time to determine the measure of interest that infant 70 exhibits in response to the presented content, the measure and/or duration of attention that infant 70 exhibits in response to the presented content or any other suitable parameter related to infant 70.

Based on signals from sensor 220 and/or any other suitable sensor, processor 230 may determine a measure of interaction of infant 70 with the presented content. For example, based on signals from sensor 220 and/or signals from a microphone 260, processor 230 may detect or recognize the speech of infant 70, gestures of infant 70 or any other suitable parameters that infant 70 exhibits in response to the presented content and based on these parameters determine the measure of interaction of infant 70 with the presented content. Based on the determined measure of interaction of infant 70 with the presented content, processor 230 may update the presented content and/or select different content to be presented to infant 70. For example, if it is determined that infant 70 exhibits low measure of interaction in response to a specific content, processor 230 may select different content and control projector 210 to present the newly selected content.

The presented content may include interactive animated characters, virtual teachers and inscriptions that may accompany the presented content, guide infant 70 through the presented content and/or provide positive and/or negative feedback. For example, based on signals from sensor 220 and/or any other suitable sensor processor 230 may determine that infant 70 has successfully completed a task, select a content that provides positive feedback (e.g., an animation of fireworks, a character giving a high five or any other suitable positive feedback) and control projector 210 to present that content to provide the feedback to infant 70. In another example, based on signals from sensor 220 and/or any other suitable sensor processor 230 may determine that infant 70 exhibits a difficulty in completing the task, processor 230 may select a content that may guide infant 70 towards fulfilment of the task and control projector 210 to present that guiding content.

Based on signals from sensor 220 or any other suitable sensor, processor 230 may determine whether or not infant 70 is overstimulated by the presented content. For example, if infant's 70 reaction to the presented content is not as expected (e.g., sudden movements in response to calm/slow content; slow movements in response dynamic content; lack of motion/speech in response to the presented content and/or any other suitable examples of not expected reaction),, it may be determined that infant 70 is overstimulated. If it is determined that infant 70 is overstimulated, processor 230 may update the presented content and/or select different content to be presented to infant 70. If it is determined that infant 70 is overstimulated, processor 230 may transmit a respective notification to the parent or the supervisor of infant 70 (e.g., using communication unit 250).

Based on signals from sensor 220 or any other suitable sensor, processor 230 may determine whether or not infant 70 is suspected to be addicted to system 200 and/or to a specific content. For example, processor 230 may terminate the presentation of the content and based on signals from sensor 220 or any other suitable sensor determine a reaction of infant 70. If in response to the termination of the presentation of the content infant 70 cries or exhibits any other negative reaction, it may be determined that infant 70 is suspected to be addicted to system 200. If it is determined that infant 70 is suspected to be addicted to system 200, processor 230 may transmit a respective notification to the parent or the supervisor of infant 70, for example using communication unit 250.

Based on the information related to the attention of infant 70 and information about the presented content, processor 230 may determine whether or not the infant's attention deviates from normal. If it is determined that the infant's attention deviates from normal, processor 230 may transmit a respective notification to the parent and/or the supervisor (e.g., via communication unit 250). For example, the information related to the attention of infant 70 in response to a specific content may be compared to the information related to attention of other infants in response to the same specific content and based on the comparison the deviation from normal may be determined. In another example, the information related to the attention of the infant and information about the presented content may be provided to a machine learning model which may be trained to output the information regarding the deviation of the attention of infant 70 from normal.

Based on information related to performance of infant 70 in response to the presented content, processor 230 may determine whether or not infant 70 exhibits extraordinary skills. The information related to performance of infant 70 in response to the presented content (such as the ability to complete the task or any other suitable parameter) may be determined by processor 230 based on signals from sensor 220 and/or any other suitable sensor. If it is determined that infant 70 exhibits extraordinary skills, processor 230 may transmit a respective notification to the parent and/or the supervisor (e.g., via communication unit 250). For example, the information related to performance of infant 70 in response to a specific content may be compared to the information related to performance of other infants in response to the same specific content and based on the comparison it may be determined that infant 70 exhibits extraordinary skills. In another example, the information related to the performance of infant 70 and information about the presented content may be provided to a machine learning model which may be trained to output whether or not infant 70 exhibits extraordinary skills.

System 200 may include a multicolor light source 270. Processor 230 may control multicolor light source 270 to illuminate a vicinity of infant 70 in different colors. Processor 230 may control multicolor light source 270 based on the presented content, ambient light and/or any other suitable parameter. For example, processor 230 may activate or increase brightness of multicolor light source 270 if there is little or no ambient light or the vicinity of infant 70 and/or deactivate or decrease brightness of multicolor light source 270 if there is a sufficient ambient light or the vicinity of infant 70 is well illuminated by other light sources. In another example, processor 230 may activate or increase brightness of multicolor light source 270 when the presented content is dark and/or deactivate or decrease brightness of multicolor light source 270 when the presented content is bright. In another example, processor 230 may control multicolor light source 270 (e.g., increase or decrease the brightness and/or the intensity of multicolor light source 270) based on the presented content to emphasize portions of the presented content and/or to bring infant's 70 attention to the presented content.

Using communication unit 250, processor 230 may communicate with mobile phones, smartphones, laptops, computers, smart internet-of-things (IoT) devices or any other suitable device having a communication interface. Processor 230 may control some of such devices via communication unit 250. For example, in smart house processor 230 may control light sources in the vicinity of infant 70.

Using a remote computing device such as a smartphone or a computer, the parent and/or the supervisor may communicate with processor 230 via communication unit 250. For example, the parent and/or the supervisor may select the content to be presented to infant 70, define times during which processor 230 is allowed to present content to infant 70, get access to information related to infant 70 that is collected by processor 230 based on signals of sensor 200 and/or any other suitable sensor (e.g., statistics, achievements, skills, etc.) and/or perform any other suitable operation. Using the remote computing device, the parent and/or the supervisor may receive images of infant 70 (e.g., images obtained by sensor 220 and/or any other suitable sensor), have a video call or otherwise communicate with infant 70.

System 200 may include a control button that may be used by infant 70 to operate (e.g., activate, deactivate, etc.) projector 210. Processor 230 may allow activation of projector 210 by the control button only during predefined periods of time (e.g., between 08:00 am to 10:00 am, between 16:00 pm to 20:00 pm and/or any other suitable period of time) and prevent projector 210 from being activated during other times. The periods of time may be set by the parent and/or the supervisor of infant 70. The control button may have a size and/or an appearance that can be easily recognized by infant 70.

System 200 may be used as an infant monitoring system. For example, based on signals from sensor 220 and/or any other suitable sensors, processor 230 may monitor parameters related to safety of infant 70. For example, based on signals from sensor 220 and/or any other suitable sensors, processor 230 may detect breathing of infant 70, movement of infant 70 and/or any other suitable parameters. If it is determined that the breathing of infant 70, the movement of infant 70 and/or any other suitable parameter is not within predefined allowable range, processor 230 may transmit a respective notification to the parent and/or the supervisor, and/or activate sound, visual or both sound and visual alarms.

Components of system 200 may be configured to prevent a potential damage that may be caused by infant 70. For example, components of system 200 may be waterproof to protect the components from saliva and/or other fluids. Components of system 200 may be configured to prevent the components from damaging infant 70. For example, components of system 200 may include rounded corners and edges and/or any other suitable safety features.

Some components of system 200 such as projector 210, sensor 220, processor 230, communication unit 250, microphone 260, light source 270 and/or any other suitable components may be packed in one housing.

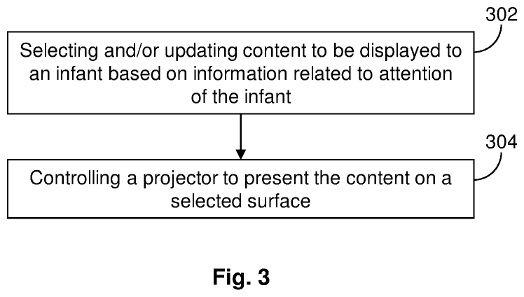

Reference is made to FIG. 3, which is a flowchart of a method for selecting and presenting content to an infant, according to some embodiments of the invention.

The operations of FIG. 3 may be performed using the equipment of FIG. 1 and/or FIG. 2 and/or using any other suitable equipment.

In operation 302, based on information related to an attention of an infant, content to be presented to the infant may be selected and/or updated by a processor (e.g., by processor 230 as described hereinabove).

The information related to the attention of the infant may be obtained using a sensor such as a camera, a 3D scanner or any other suitable sensor (e.g., such as sensor 220 described hereinabove). For example, based on signals from the sensor, the direction of gaze of the infant may be determined by the processor. Based on the direction of gaze, a measure of the attention of the infant to the presented content may be determined. If it is determined that the infant exhibits low attention to the presented content, the presented content may be updated and/or different content may be selected by the processor (e.g., as described hereinabove). Parameters other than the direction of gaze may be used to determine the measure of the attention of the infant to the presented content. Such parameters may, for example, include the facial expression of the infant, the orientation of the body and/or the face of the infant, the gestures of the infant and/or any other suitable parameter (e.g., as described hereinabove).

In operation 304, a projector (e.g., projector 210 described hereinabove) may be controlled to present the content on a selected surface (e.g., by processor 230 as described hereinabove).

The display parameters of the projector may be defined (e.g., by the processor) based on a location of the projector in a facility (e.g., as described hereinabove). For example, for each location in the facility, display parameters of the projector may be predefined and stored (e.g., as described hereinabove). The location of the projector in the facility may be determined (e.g., by the processor) based on signals from a sensor in a docking station (e.g., such as docking station 240), for example as described hereabove. The display parameters of the projector may be determined and/or adjusted by the processor based on parameters such as the distance between the projector and the selected surface and/or the orientation of the projector with respect to the selected surface (e.g., as described hereinabove).

The projector may be controlled by the processor to select a region in the selected surface and to present the content in the selected region (e.g., as described hereinabove). The selected region may be a region that has no objects, drawing or any patterns that may interfere with the presented content.

The projector may be controlled by the processor to select the focus area of the projector. The focus area of the projector may be selected and/or updated based on information related to the infant (e.g. gaze direction) or based on the content presented. If the infant's gaze is outside the projected area boundaries, focus may be given to a particular area of the projected area where more action is happening than in another areas of the projected area. For example, focus may be given to the top area of the projected area when the content is a dialog between figures, or the bottom area of the projected area when content is a cartoon.

The content to be presented may be selected and/or updated based on information related to the infant (e.g., as described hereinabove). A portion of the information may be provided by the parent and/or the supervisor, for example using a communication unit (e.g., such as communication unit 250 described hereinabove). A portion of the information may be determined by the processor based on signals from the sensor(s) (e.g., as described hereinabove).

Based on signals from the sensor and/or any other suitable sensor, a measure of interaction of the infant with the presented content may be determined by the processor (e.g., as described hereinabove). Based on the determined measure of interaction of the infant with the presented content, the presented content may be updated and/or different content may be selected by the processor (e.g., as described hereinabove).

The presented content may include interactive animated characters, virtual teachers and inscriptions that may accompany the presented content, guide the infant through the presented content and/or provide positive and/or negative feedback. For example, based on signals from the sensor(s) it may be determined by the processor that the infant has successfully completed a task, a content that provides positive feedback (e.g., an animation of fireworks, a character giving a high five or any other suitable positive feedback) may be selected by the processor and the projector may be controlled by the processor to present that content to provide the feedback to the infant (e.g., as described hereinabove). In another example, based on signals from the sensor(s) it may be determine that the infant exhibits a difficulty in completing the task, a content that may guide the infant towards fulfilment of the task may be selected by the processor and the projector may be controlled by the processor to present that guiding content (e.g., as described hereinabove).

Based on signals from the sensor or any other suitable sensor, it may be determined whether or not the infant is overstimulated by the presented content (e.g., as described hereinabove). If it is determined that the infant is overstimulated, the content may be updated and/or different content may be selected by the processor (e.g., as described hereinabove). If it is determined that the infant is overstimulated, a respective notification may be transmitted by the processor to the parent and/or the supervisor of the infant (e.g., as described hereinabove).

Based on signals from the sensor or any other suitable sensor, it may be determined whether or not the infant is suspected to be addicted to the system and/or to a specific content (e.g., as described hereinabove). If it is determined that the infant is suspected to be addicted to the system and/or the specific content, a respective notification may be transmitted by the processor to the parent and/or the supervisor of the infant (e.g., as described hereinabove).

Based on the information related to the attention of the infant and information about the presented content, it may be determined by the processor whether or not the infant's attention deviates from normal (e.g., as described hereinabove). If it is determined that the infant's attention deviates from normal, a respective notification may be sent to the parent and/or the supervisor by the processor (e.g., as described hereinabove).

Based on information related to performance of the infant in response to the presented content, it may be determined by the processor whether or not the infant exhibits extraordinary skills (e.g., as described hereinabove). If it is determined that the infant exhibits extraordinary skills, a respective notification may be transmitted by the processor to the parent and/or the supervisor (e.g., as described hereinabove).

The vicinity of the infant may be illuminated in different colors by a multicolor light source (e.g., multicolor light source 270 as described hereinabove). The multicolor light source may be controlled by the processor based on the presented content, ambient light and/or any other suitable parameter (e.g., as described hereinabove).

Based on signals from the sensor(s), parameters related to safety of the infant may be monitored by the processor (e.g., as described hereinabove).

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes. Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A system for selecting and presenting content to an infant, the system comprising:
a projector configured to present content on a selected surface;
a sensor configured to obtain information related to attention of an infant; and
a processor configured to:
based on the information related to an attention of the infant, at least one of select and update content to be presented to the infant; and
control the projector to present the content.

2. The system of claim 1, wherein the sensor comprises a camera or a three-dimensional scanner, and wherein the processor is configured to:
based on signals from the sensor, determine a direction of gaze of the infant, and
based on the direction of gaze, determine a measure of attention of the infant to the presented content.

3. The system of claim 1, wherein the processor is configured to define display parameters of the projector based on a location of the projector in a facility.

4. The system of claim 2, wherein the processor is configured to define a focus area of the projector based on the direction of gaze of the infant.

5. The system of claim 2, wherein the processor is configured to define a focus area of the projector based on the presented content.

6. The system of claim 1, comprising a docking station in which the projector may be placed, the docking station comprising a location sensor configured to provide information concerning a location of the projector in a facility.

7. The system of claim 1, wherein the processor is configured to select a region in the selected surface and to control the projector to present the content in the selected region.

8. The system of claim 1, wherein the processor is configured to monitor parameters related to safety of the infant based on signals from the sensor.

9. The system of claim 1, comprising a multicolor light source, wherein the processor is configured to control the multicolor light source to illuminate a vicinity of the infant in different colors.

10. The system of claim 9, wherein the processor is configured to control the multicolor light source based on at least one of the presented content and ambient light.

11. The system of claim 1, wherein the projector comprises a piece of material surrounding a lens of the projector and partly overlapping with the lens to smooth borders of the presented content.

12. The system of claim 1, comprising a mirrors assembly for projecting the presented content in a selected direction.

13. The system of claim 1, wherein the processor is configured to select infant-specific content based on information related to the infant.

14. The system of claim 1, wherein the processor is configured to, based on the information related the attention of the infant and information about the presented content, determine a deviation of the infant's attention from normal.

15. The system of claim 1, wherein the processor is configured to determine a measure of addiction of the infant to a system and to select the content based on the measure of addiction.

16. The system of claim 1, wherein the processor is configured to control the projector to provide feedback to the infant.

17. A method of selecting and presenting content to an infant, the method comprising, using a computing device operating a processor:
based on information related to an attention of an infant, at least one selecting and updating content to be presented to the infant; and
controlling a projector to present the content on a selected surface.

18-30. (canceled)
